(19) United States
(12) Patent Application Publication
(10) Pub. No.: US 2016/0005055 A1
(43) Pub. Date: Jan. 7, 2016

(54) GENERIC TIME SERIES FORECASTING

(71) Applicant: Siar Sarferaz, Heidelberg (DE)

(72) Inventor: Siar Sarferaz, Heidelberg (DE)

(21) Appl. No.: 14/321,414

(22) Filed: Jul. 1, 2014

(51) Int. Cl. G06Q 30/02; G06Q 10/04; G06F 17/30

(52) U.S. Cl. CPC G06Q 30/0202; G06F 17/30353; G06Q 10/04

(57) ABSTRACT

A generic time series forecasting system receives historical time series data and one or more initial parameter values for one or more parameters of a predictive algorithm, such as an exponential smoothing algorithm. The generic time series forecasting system iteratively determines an optimized value for each of one or more parameters for the predictive algorithm based on the received historical time series data and the received one or more initial parameter values. The generic time series forecasting system generates and outputs data for a forecasted time series based on the iteratively optimized value for each of the one or more parameters, the received historical time series data, and the predictive algorithm.

### BACKGROUND

Entities, such as businesses, may utilize systems to predict future data based on current and/or historical performance data. Such current and/or historical performance data may be used, in some instances, for analysis and/or reporting for the entity about the performance of the entity. Such current and/or historical performance data may also be used in predictive analysis to make predictions or projections using the current and/or historical performance data. Predicting the future of aspects of an entity, such as a business, based on past time series is of interest in many scenarios. However, such time series predictions generally require statistical knowledge and/or configuration effort to tailor a predictive model to the data.

### SUMMARY

One embodiment of the invention relates to a method for generating a time series forecast. The method includes receiving historical time series data from a client device and receiving one or more initial parameter values for an exponential smoothing algorithm. The method also includes iteratively determining an optimized value for each of one or more parameters for the exponential smoothing algorithm based on the received historical time series data and the received one or more initial parameter values. The method further includes generating data for a forecasted time series based on the iteratively optimized value for each of the one or more parameters, the received historical time series data, and the exponential smoothing algorithm. The method still further includes outputting the generated data for the forecasted time series to the client device.

In another implementation, a system includes a processing module and a non-transitory computer-readable storage device storing instructions that, when executed by the processing module, cause the processing module to perform several operations. The operations include receiving historical time series data and receiving one or more initial parameter values for a triple exponential smoothing algorithm. The operations also include iteratively determining an optimized value for each of the one or more parameters for the triple exponential smoothing algorithm based on the received historical time series data and the received one or more initial parameter values. The operations further include generating data for a forecasted time series based on the iteratively optimized value for each of the one or more parameters, the received historical time series data, and the triple exponential smoothing algorithm. The operations still further include outputting the generated data for the forecasted time series.

In yet a further implementation, a non-transitory computer-readable storage device may store instructions that, when executed by a processing module, cause the processing module to perform several operations. The operations include receiving historical time series data and several initial parameter values for a triple exponential smoothing algorithm. The operations also include iteratively determining an optimized value for each of several parameters for the triple exponential smoothing algorithm based on the received historical time series data and the received several initial parameter values. The iterative determination of the optimized values for each of the several parameters for the triple exponential smoothing algorithm includes generating a set of forecasted values using the triple exponential smoothing algorithm and the several initial parameter values and determining a fit of one or more of the set of forecasted values to one or more values of the historical time series data using an optimizer. The operations further include generating data for a forecasted time series based on the iteratively optimized value for each of the several parameters, the received historical time series data, and the exponential smoothing algorithm. The operations still further include outputting the generated data for the forecasted time series in a view.

### BRIEF DESCRIPTION

Various embodiments taught herein are illustrated by way of example, and not by way of limitation, in the figures of the accompanying drawings, in which:

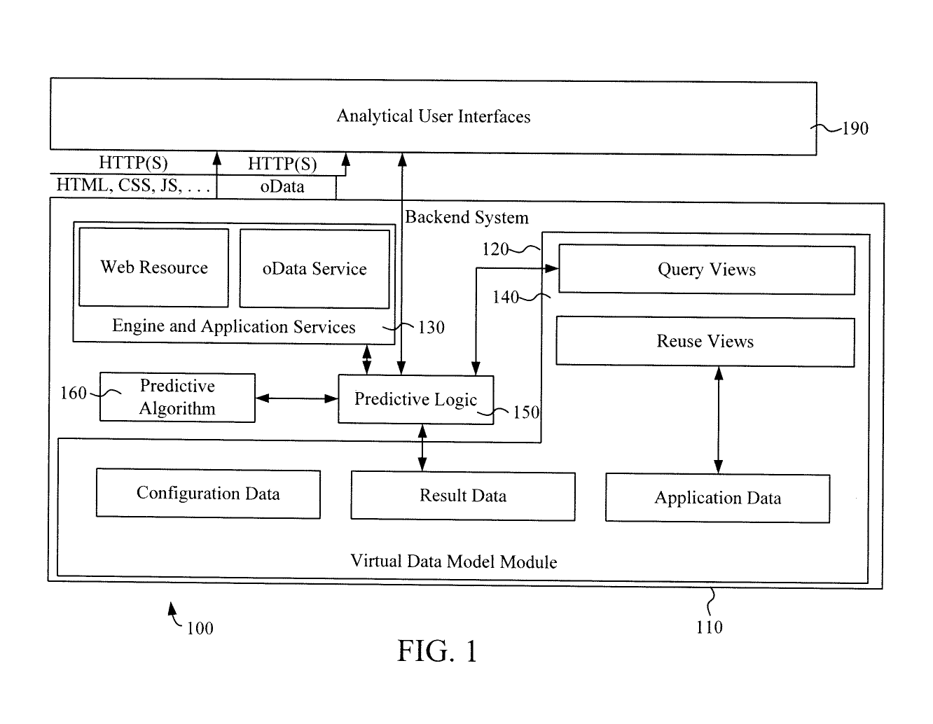

FIG. 1 is a block diagram of an example backend system for interfacing with analytical user interfaces;

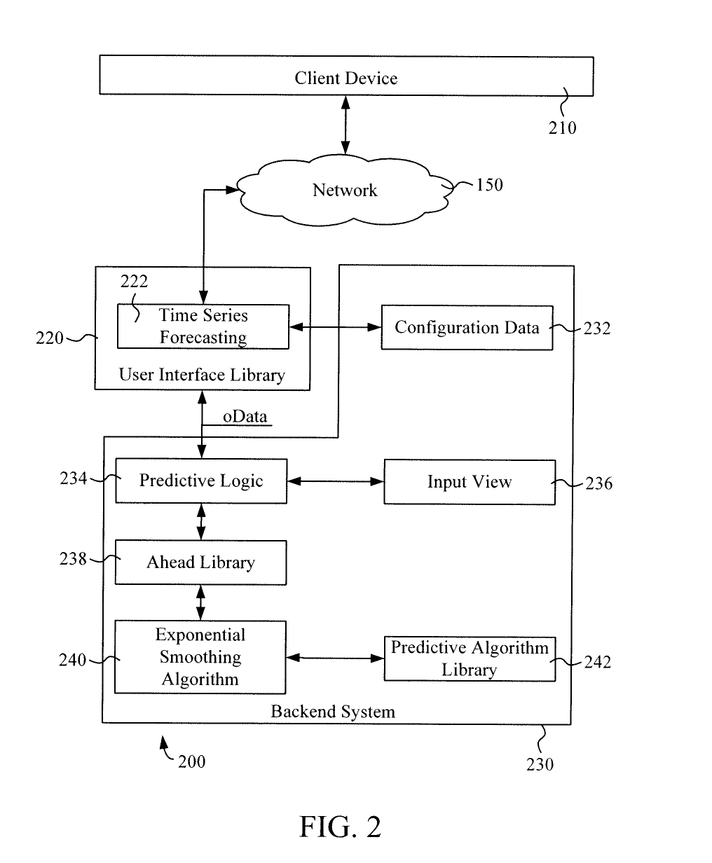

FIG. 2 is a block diagram of an implementation of a generic time series forecasting system;

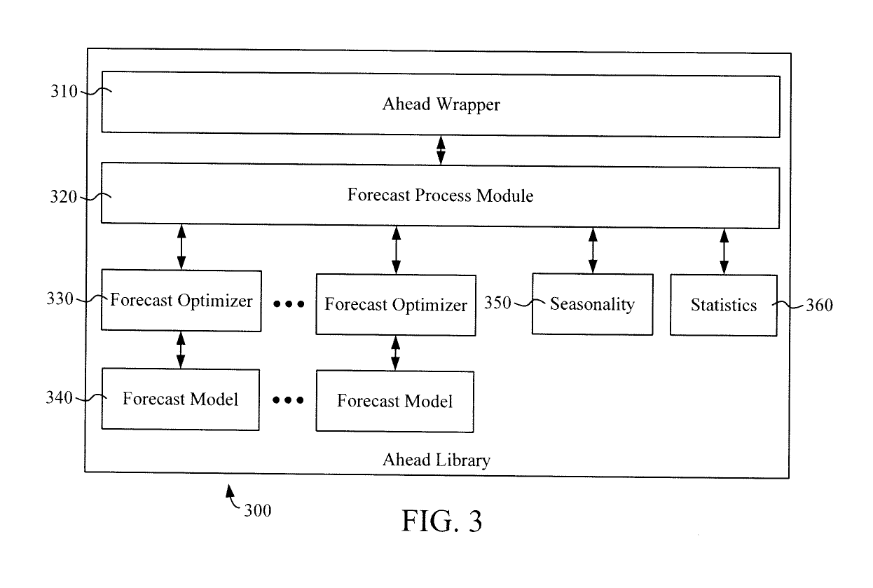

FIG. 3 is a block diagram of an implementation of an ahead library for iteratively optimizing one or more parameters of a forecast model and generating data for a forecasted time series;

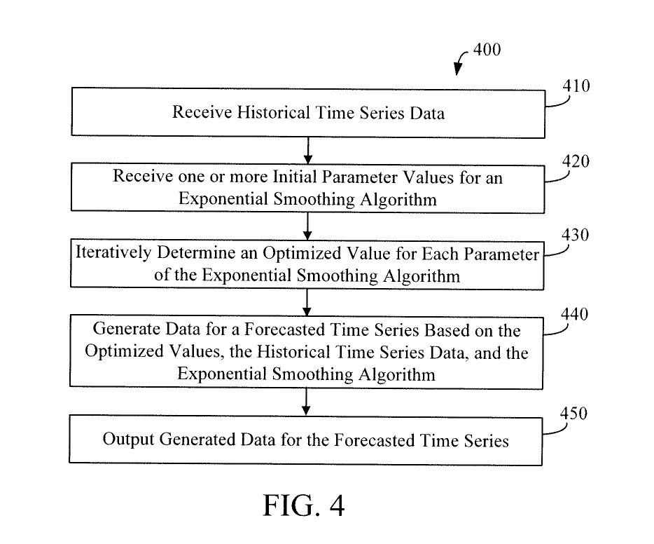

FIG. 4 is a flow diagram of an implementation of a process for generating a time series forecast;

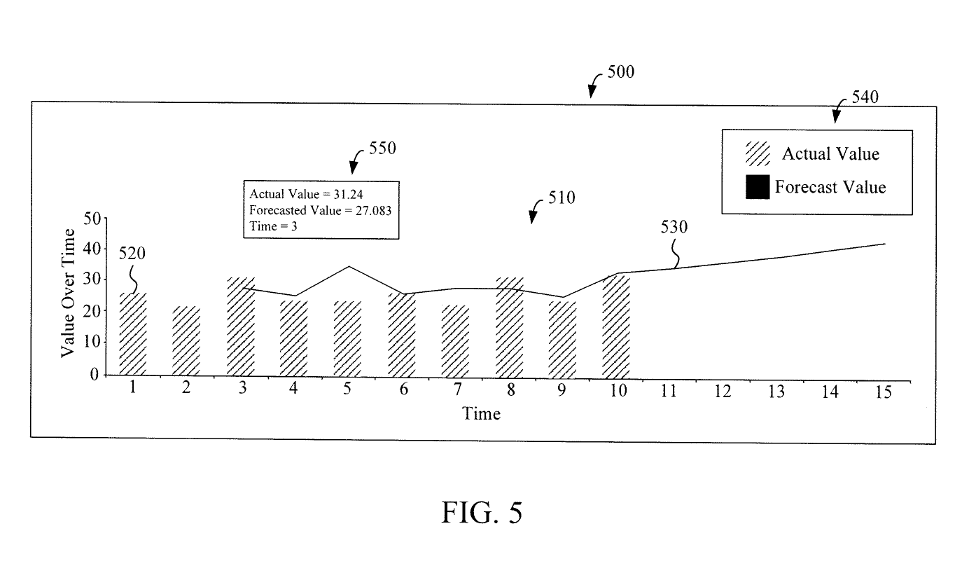

FIG. 5 is an overview of an implementation of a visualization and interface that may be generated based on a generated time series forecast; and

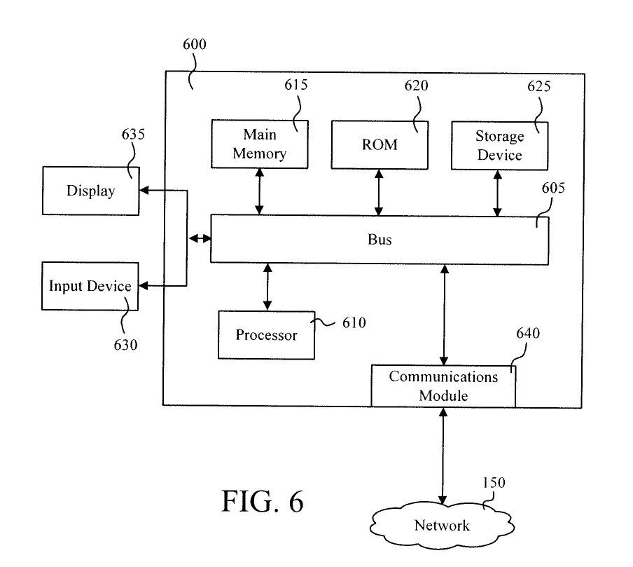

FIG. 6 is a block diagram illustrating an architecture for a computer system that may be employed to implement various elements of the systems and methods.

It will be recognized that some or all of the figures are schematic representations for purposes of illustration only. The figures are provided for the purpose of illustrating one or more implementations with the explicit understanding that they will not be used to limit the scope or the meaning of the claims.

### DETAILED DESCRIPTION

The following is merely provided for example purposes with the explicit understanding that the examples described herein will not be used to limit the scope or the meaning of the claims.

I. Overview

Entities, such as businesses, utilize data in a variety of ways. For example, businesses may collect and integrate business data into business databases and/or data warehouses and report or otherwise utilize the data using business software. Business data may come with timestamps such that the business data values and timestamps may be used in predicting future values for various business scenarios. The variation of quantity over time is called time series, and predicting future values based on current and/or historical existing time series is known as forecasting. In some instances, such business data is utilized by data scientists with predictive algorithms to generate predicted or forecast data based on current and/or historical performance data. Such data scientists, with the assistance of information technology professionals, help organize and use predictive algorithms to generate analytical reports based on the predictions. The data scientists identify a suitable algorithm, optimize the parameters for the identified algorithm, and the corresponding data for the requested predicted or forecast data. Currently, predictive analysis tools are not designed for end users and such tools require a greater understanding of the underlying algorithms to arrive at the desired predicted or forecast data.

Accordingly, it may be useful to provide a generic time series forecasting system that can optimize the parameters for a predictive algorithm and generate predicted or forecast time series data such that the end-user simply needs to identify the current and/or historical performance data. Such a simplified system may not require any in-depth statistical knowledge and/or may not require configuration effort from end user. Moreover, the initial training and continuous adaption of one or more forecasting models may be handled automatically.

In some implementations, the current and/or historical performance data may be received by a backend system, such as SAP®'s HANA Analytics Foundation product. The current and/or historical performance data may be received via an input view. The backend system may receive one or more initial parameter values for a predictive algorithm, such as an exponential smoothing algorithm, to be used in generating the forecasted time series data. The backend system may then iteratively determine an optimized value for each parameter for the predictive algorithm based on the received current and/or historical performance data and the received one or more initial parameter values. Such iterative determining of the optimized parameter values for the predictive algorithm may be performed sequentially, in parallel, and/or a combination thereof. The backend system may then generate data for a forecasted time series based on the iteratively optimized value for each of the parameters for the predictive algorithm, the received historical time series data, and the predictive algorithm. The backend system may output the generated data for the forecasted time series to a client device, such as in the form of a data table or data set, a visualization, and/or other format to be consumed by an end-user. In some implementations, the outputted generated data for the forecasted time series may be accessed by SQL, ODATA, ODBC or MDX. In some implementations, to harmonize and simplify the visualization of the data for the forecasted time series a reusable user interface may be provided. The user interface may generate a visualization based on the outputted generated data for the forecasted time series and the actual current and/or historical performance data to depict both the forecasted time series and the underlying actual data. In some implementations, the user interface may include tolerance boundaries for the forecasted values. Configuration data for the user interface may also be outputted for configuring the user interface and/or aspects of the visualization.

Implementations of systems and methods for implementing the foregoing will now be described in greater detail.

II. Example Backend System

FIG. 1 depicts an example system 100 for interfacing with analytical user interfaces. The system 100 includes a backend system 110 and analytical user interfaces 190 of client devices interacting with the backend system 110. The backend system 110 and the analytical user interfaces 190 of one or more client devices may be in communication via a network, such as network 150 of FIG. 2. The backend system 110 of the present example comprises a server or collection of servers that include an engine and application services 130 and a virtual data model module 140. The server or servers of the backend system 110 may be a computing device, such as computing device 600 of FIG. 6, and/or the server or servers may be configured otherwise. In some instances, the backend system 110 may comprise several computing devices, such as a cloud server, etc. In the present example, the backend system 110 may be the HANA platform offered by SAP®.

The engine and application services 130 permit exposure of one or more views of the virtual data model module 140 to the analytical user interfaces 190. In the example shown, the engine and application services 130 include web resources and Open Data Protocol (oData) services to permit an end user to interact with the backend system 110 via a web interface and/or through another application. In some implementations, specific analytical user interfaces may be provided for an end user to interact with the backend system 110. Such specific analytical user interfaces may be web-based user interfaces that may be configured using HyperText Markup Language (HTML), HTML5, Cascading Style Sheets (CSS), JavaScript®, etc. In some implementations, the specific analytical user interfaces may use oData to access and/or interact with the backend system 110. In other implementations, the specific analytical user interfaces may use SQL to access and/or interact with the backend system 110. The specific analytical user interfaces may be customized to provide a business-specific and/or user-specific interface. In other implementations, generic analytical user interfaces (e.g., BOBJ, 3rd Party) may be provided for an end user to interact with the backend system 110 such that other business software or third-party software may interact with the backend system 110.

The backend system 110 may include an analytics foundation that is configured to access the data tables of a database layer and/or receive inputted data received from the analytical user interfaces 190. In some implementations, the backend system 110 includes predictive logic 150, one or more predictive algorithms 160, and the virtual data model module 140. In some implementations, the predictive logic 150, one or more predictive algorithms 160, and the virtual data model module 140 may be included as part of the analytics foundation.

The predictive logic 150 may be a script, such as SQL or JavaScript®, or other code for invoking and/or orchestrating the one or more predictive algorithms 160. The predictive logic 150 may be implemented in a calculation view. For instance, the predictive logic may be an SQL script that may access a database of predictive algorithms 160, such as a predictive analysis library (PAL) used by the HANA platform offered by SAP®. The predictive analysis library may be an application function library that offers various predictive algorithms 160, such as statistical and data mining algorithms.

The back end system 110 also includes the virtual data model module 140, which can include various views for receiving, interacting with, and/or outputting data. A collection of query views may be provided as a top layer of the virtual data model module 140. In the example shown, the virtual data model module 140 includes query views and reuse views, though the virtual data model module 140 may include private views, personalized views, and/or extensions. The predictive logic 150 interacts with the query views of the virtual data model module 140 for receiving data as input for computation using the predictive algorithms 160. In some implementations, the query view may be a simple and standard access mechanism that is reused receiving data. If existing query views are not sufficient to read the required input data, SQL techniques can be used to enhance the existing query views and/or to define new query views. In addition to receiving data via the query views, the virtual data model module 140 may include configuration parameters, e.g. the maximum number of clusters for a clustering algorithm, etc., that may be stored in specific tables and encapsulated with one or more query views. Depending on the execution time of the algorithms the results can be provided to the analytical user interface 190 immediately or may be stored in a database for retrieval. In some implementations, the query views may be offered to expose the stored results. The predictive logic 150 and/or the resulting data can be triggered from the analytical user interfaces 190 directly or using the engine and application services 130. In some implementations, the virtual data model module 140 may be part of a HANA Analytic Foundation offered by SAP®.

In some current implementations, inputted data for the predictive algorithms 160 may be provided via interaction with a query view for a user to define or provide the values for the input data. In other implementations, input views may be defined for a user to define or provide the values for the input data. The control parameters for the predictive algorithms 160 may be stored in tables and exposed using control views that may permit a user to modify or define the control parameters used by the predictive algorithms 160 when operating on the inputted data. In other implementations, the control parameters may be predetermined in the predictive logic 150. Thus, a user or data scientist may need to determine and define the control parameters prior to utilizing the predictive algorithm 160 on the inputted data for useful results to be generated. For instance, the predictive logic 150 may include a script such as:

BEGIN
inseries = SELECT “Month” AS ID, “Values” AS RAWDATA
FROM “InputView”
INSERT parameters VALUE (
(‘forecast_horizon’, 10, null, null),
(‘alpha’, null, 0.4, null),
(‘beta’, null, 0.8, null),
(‘gamma’, null, 0.2, null),
(‘season1_length’, 24, null, null),
(‘season2_length’, 168, null, null),
(‘season3_length’, 720, null, null),
(‘autocorrelation’, null, 0.6, null),
(level’, null, 0.2, null));
CALL FORECAST(inseries, parameters, outseries);
var_out = SELECT “Time”, “Output” FROM :outseries
END;

In the foregoing example script, the inputted data for the predictive algorithms 160 is received via an input view of the virtual data model module 140, InputView, as RAWDATA with an ID of Months. That is, the expected inputted data is value data for a series of months. The example script also specifies control parameters for the predictive algorithm 160, though the control parameters may, in other implementations, be read from a configuration table. The FORECAST predictive algorithm 160 is called and receives the inputted data and the control parameters. The output results from the FORECAST predictive algorithm 160, such as a generated time series forecast, is received as part of the outseries variable. In some implementations, the generated results generated based on the predictive algorithm 160, the inputted data, and the control parameters can be stored in a table and/or provided to the analytical user interfaces 190. In the script example above, the results are assigned to the scripted calculation view's output structure, var_out. In some implementations, the results can be accessed by using SQL or OData services.

As noted above, a user or data scientist may need to determine and define the control parameters prior to utilizing the predictive algorithm 160 on the inputted data for useful results to be generated. It may be useful to provide an automated, generic system that can determine and/or optimize the control parameters such that a user may need to provide only the inputted data to generate the time series forecast.

III. Example Backend System for Generic Time Series Forecasting

FIG. 2 depicts a block diagram of an implementation of a generic time series forecasting system 200. A client device 210 may interact with the generic time series forecasting system 200 via a network 150. The client device 210 may be a computing device, such as computing device 600 of FIG. 6. The client device 210 may include an interface for accessing and/or otherwise interacting with the generic time series forecasting system 200. The interface may be any interface for permitting a user of the client device 210 to interact with the generic time series forecasting system 200. The client device 210 may also include a communications module, such as communications module 640 of FIG. 6, for providing a communication link between the client device 210 and the network 150. As such, the communications module enables the client device 210 to communicate, wired or wirelessly, with other electronic systems, such as the generic time series forecasting system 200, in communication with the network 150. For instance, the communications module may be coupled to an Ethernet line that connects the client device 210 to the Internet or another network 150. In other implementations, the communications module may be coupled to an antenna and provides functionality to transmit and receive information over a wireless communication interface with the network 150.

The generic time series forecasting system 200 includes a user interface library 220 and a backend system 230. In some implementations, the user interface library 220 may be integrated into the backend system 230. In other implementations, the user interface library 220 may be integrated into the client device 210, such as via an application hosted and executing on the client device 210. The backend system 230 may be configured in a similar manner to backend system 110. The user interface library 220 may include several user interfaces to be selected and presented to a user via the client device 210. For instance, a time series forecasting user interface 222 may be provided in the user interface library 220, which may be presented to the user via the client device 210 when utilizing the generic time series forecasting described herein. In some implementations, the time series forecasting user interface 222 may include an input feature for inputting and/or defining input data to be used for generating a time series forecast. The input feature may include a file upload and/or specification feature, a text box for entering data, etc. The time series forecasting user interface 222 is configured to interact with the backend system 230 by providing the inputted data to be used in generating the time series forecast and receiving the generated time series forecast from the backend system 230. The time series forecasting user interface 222 may be provided by a local application, a web application, and/or any other method for allowing a user of the client device 210 to provide input and/or receive output from the backend system 230. In one implementation, the time series forecasting user interface 222 may be provided via an application executing on the client device 210. In another implementation, the time series forecasting user interface 222 may be provided via HTML5 or JavaScript on a web browser of the client device 210. Of course other ways of providing the time series forecasting user interface 222 may be implemented as well.

In some implementations, such as that shown in FIG. 5, the time series forecasting user interface 222 may be configured to provide a visualization of the inputted data and the generated time series forecast data, such as a bar graph, line graph, etc. The time series forecasting user interface 222 may be further configured to permit a user to interact with the underlying data, such as hovering or mousing over a portion of the visualization to display information about the underlying inputted data and/or generated time series forecast data, such as a pop-up tool tip displaying the generated time series forecast data and/or the inputted data for a time value corresponding to where the mouse is positioned over the visualization. In some implementations, the time series forecasting user interface 222 may retrieve configuration data 232 from the backend system 230 for configuring the time series forecasting user interface 222.

The backend system 230 includes the configuration data 232 for the time series forecasting user interface 222, predictive logic 234, an input view 236, an ahead library 238, an exponential smoothing algorithm 240, and a predictive algorithm library 242. As noted above, the configuration data 232 is used for configuring the time series forecasting user interface 222, such as providing styling data for a generated visualization, interaction data for providing one or more interactive features of the time series forecasting user interface 222, such as pop-up informational windows when hovering or mousing over a portion of a visualization, etc. The configuration data 232 may be stored in a configuration database (not shown) and retrieved responsive to the time series forecasting user interface 222 being requested by a client device 210 from the user interface library 220. In some implementations, several different configuration data sets may be stored in the configuration database for various user interfaces of the user interface library 220.

The backend system 230 further includes predictive logic 234 that may be accessed by the time series forecasting user interface 222 and is configured to invoke and/or orchestrate various aspects of the backend system 230 to generate the time series forecast for the time series forecasting user interface 222. For instance, the predictive logic 234 may access an input view 236 for the time series forecasting user interface 222 for a user of the client device 210 to provide historical time series data as inputted data to be utilized by a predictive algorithm. The predictive logic 234 may also interact with an ahead library 238. For instance, the predictive logic 234 may include a script such as:

BEGIN
inseries = SELECT “Month” AS ID, “Values” AS RAWDATA
FROM “InputView”
INSERT parameters VALUE (
(‘forecast_horizon’, 10, null, null),
(‘forecast_automatic’, null, null, ‘true’));
CALL FORECAST(inseries, parameters, outseries);
var_out = SELECT “Time”, “Output” FROM :outseries
END;

In the example script above, the control parameters are omitted and an automatic forecast parameter, forecast_automatic, is provided for invoking the ahead library 238. As will be described in greater detail below, the ahead library 238 determines and/or optimizes one or more control parameters for the predictive algorithm utilized such that a user only needs to provide the historical time series data. The predictive logic 234 may be implemented as a scripted calculation view. The generated time series forecast results may be exposed via the output structure of the scripted calculation view. In some implementations, the generated time series forecast data can be accessed by SQL, ODATA, ODBC, and/or MDX. In some implementations, the generated time series forecast data may be provided to the time series forecasting user interface 222 to be displayed as part of a visualization of the time series forecasting user interface 222. This time series forecasting user interface 222 may visually demonstrate the actual and forecasted data, including tolerance boundaries for the predicted values.

IV. Example Ahead Library

The ahead library 238 invokes and/or orchestrates one or more predictive algorithms of the backend system 230, one or more optimizers for optimizing one or more parameters, such as control parameters, for the one or more predictive algorithms, and/or calculation modules, such as a seasonality module, etc. In some implementations, the ahead library 238 interacts with an exponential smoothing algorithm 240. The exponential smoothing algorithm 240 may interact with one or more subroutines and/or other algorithms that may be stored in a predictive algorithm library 242. For instance, the HANA platform offered by SAP® includes a predictive algorithm library 242 that provides exponential smoothing algorithms 240 for time series forecasting. In some implementations, the exponential smoothing algorithm 240 may be a triple exponential smoothing algorithm. The exponential smoothing algorithms 240 also support handling of trends and seasonality that may be stored as algorithms in the predictive algorithm library 242.

Exponential smoothing algorithms utilize weighted historical time series values to predict future time series values. The older the historical time series value, the less important the value will be to predicting a future value. In one implementation, a naïve forecasting algorithm may simply equate a future time series value to the previous time series value. In another implementation, a naïve forecasting algorithm may equate a future time series value to an average of two or more time series values. In a single exponential smoothing algorithm, an equation, such as:

Fₜ₊₁=αXₜ+α(1−α)Xₜ₋₁+α(1−α)2Xₜ₋₂+ . . . +α(1−α)nXₜ₋ₙ=αXₜ+(1−α)Fₜ

may be used, where α is between 0 and 1. In a triple exponential smoothing algorithm, an equation, such as:

Fₜ₊ₘ=(Sₜ+bₜm)I_{t-L+m}

may be used, where Sₜ=αXₜ/I_{t-L}+(1−α)(Sₜ₋₁+bₜ₋₁) is representative of a stationary element, bₜ=γ(Sₜ−Sₜ₋₁)+(1−γ)bₜ₋₁ is representative of a trend element, and Iₜ=βXₜ/Sₜ+(1−β)I_{t-L} is representative of a seasonality element.

The exponential smoothing algorithms 240 may be parameterized before the exponential smoothing algorithm 240 is called. That is one or more values of control parameters, such as smoothing constants or a number of values to be forecasted, may be determined prior to utilizing the exponential smoothing algorithm 240 with the received historical time series data to generate the time series forecast. The determination of the control parameters for the exponential smoothing algorithm 240 may be performed by the ahead library 238. For a triple exponential smoothing algorithm, the control parameters may include three smoothing constants, alpha (α), beta (β), and gamma (γ). The ahead library 238 is configured to calculate on the fly a set of optimal parameters for the exponential smoothing algorithm 240 so that a user need only provide the historical and/or current times series data to generate the time series forecast.

FIG. 3 depicts a block diagram of an implementation of an ahead library 300 for iteratively optimizing one or more control parameters of a forecast model and generating data for a forecasted time series. The ahead library 300 includes an ahead wrapper 310, a forecast process module 320, one or more forecast optimizers 330, one or more forecast models 340, a seasonality module 350, and a statistics module 360. The ahead wrapper 310 is the entry point to the ahead library 300. The ahead wrapper 310 receives the historical and/or current times series data from the predictive logic 234. The historical and/or current time series data may be stored and/or formatted into a data table containing a set of value pairs. Each value pair may include a timestamp and a value. The timestamp may be a specific time, e.g., 12:34.56 PM, and/or date combination. In other implementations, the timestamp may be a discretized or bucketized value, such as values indicative of a month (e.g., 1=January, 2=February, etc.), a quarter, a year, a day, etc. The values are the historic time series data to be used to generate the time series forecast using one or more predictive models. In addition to receiving the historical and/or current time series data, the ahead wrapper 310 may also receive an initial set of one or more parameter values, such as an initial set of values for the control parameters to be used when iteratively optimizing one or more parameter values for the predictive algorithm used. In some implementations, the received initial set of one or more parameter values may be passed as a data table from a database. In other implementations, the one or more initial set of one or more parameter values may be defined as part of the ahead library 300. The ahead wrapper 310 also outputs the generated time series forecast data. In some implementations, the generated time series forecast data may be output as a data table containing the forecast values and may, in some implementations, include an output parameter table containing the values for the optimized one or more parameters and/or runtime statistics of the optimization.

The inputted historical and/or current time series data received by the ahead wrapper 310 is passed to the forecast process module 320. The forecast process module 320 implements control flow for the optimization of the one or more parameters for the predictive algorithm used to generate the time series forecast data. The forecast process module 320 instantiates and controls the life cycle of one or more forecast optimizers 330, one or more forecast models 340 (e.g., one or more predictive algorithms), the seasonality module 350, and the statistics module 360. In some implementations, the forecast process module 320 may instantiate and run several forecast optimizers 330 and forecast models 340 in parallel.

A forecast optimizer 330 receives the historical and/or current time series data and the initial values for the one or more parameters from the forecast process module 320. The forecast optimizer 330 may be a global or local optimizer. For instance, a forecast optimizer 330 may be a global optimizer, such as an optimizer implementing a simulated annealing process. In other implementations, the forecast optimizer 330 may be a local optimizer, such as an optimizer implementing a Nelder Mead method. In still further implementations, both a global and a local optimizer may be utilized, such as both an optimizer implementing a simulated annealing process and an optimizer implementing a Nelder Mead method. Each forecast optimizer 330 iteratively fits an associated forecast model using several iterations of one or more parameter combinations. That is, the forecast optimizers 330 may utilize a forecast algorithm 340, such as an exponential smoothing algorithm, to generate time series forecast data based on the received historical and/or current time series data and one or more parameters for the forecast algorithm 340. The forecast optimizer 330 may then determine the fit of the generated time series forecast data to one or more values of the received historical and/or current time series data. Determining the fit may include calculating a difference between a value of the generated time series forecast data and a corresponding historical and/or current time series data. The determination of the fit may implement a global and/or local optimization process. Depending upon the determined fit, a value of one or more of the parameters may be modified. The forecast optimizer 330 may then use the modified value for the one or more parameters to generate a second, new time series forecast data. The forecast optimizers 330 may iterate through various values for the one or more parameters for the forecast model 340 to iteratively determine an optimized value for each of the one or more parameters based on the received historical and/or current time series data.

For instance, the forecast optimizers 330 may generate a set of forecasted values using a forecast model 340, such as a triple exponential smoothing algorithm, and one or more received initial parameter values. The forecast optimizer 330 may then determine a fit of one or more of the set of forecasted values to one or more values of the historical and/or current time series data. The forecast optimizer 330 may then modify a value of the one or more parameters based on the determined fit and generate a second set of forecasted values using the forecast model 340 and the modified value of the one or more parameters.

In some implementations, the forecast optimizers 330 may be limited by a predetermined period of time, a predetermined number of iterations, a predetermined error value, etc. For instance, the predetermined period of time may be five seconds, ten seconds, thirty seconds, one minute, five minutes, ten minutes, etc. The forecast optimizer 330 may iteratively determine and optimize the values for the one or more parameters until the elapsed time (such as that determined using a timer) meets or exceeds the predetermined period of time. In other implementations, the predetermined number of iterations may be 10 iterations, 100 iterations, 1,000 iterations, 10,000 iterations, 100,000 iterations, 1,000,000 iterations, 10,000,000 iterations, etc. The forecast optimizer 330 may iteratively determine and optimize the values for the one or more parameters until the number of iterations meets or exceeds the predetermined number of iterations. In still further implementations, the predetermined error value may be 10%, 5%, 1%, 0.5%, 0.1%, 0.05%, 0.01%, etc. The forecast optimizer 330 may iteratively determine and optimize the values for the one or more parameters until the error meets or is below the predetermined error value.

Once the optimized values for the one or more parameters is determined, the forecast process module 320 may generate and/or retrieve the corresponding data for a forecasted time series based on the iteratively optimized value for each of the one or more parameters, the received historical time series data, and the forecast model 340. In some implementations, the forecast optimizers 330 may also provide runtime statistics, such as the number of iterations used for the overall fitting, the elapsed time, the determined error, a determined tolerance, etc. The runtime statistics may be included in the statistics module 360. In some implementations, the values for the optimized one or more parameters may also be included in the statistics module 360. The stored runtime statistics and/or optimized parameter values may be outputted with the generated time series forecast data and/or may be stored and used for analysis of the performance of the generic time series forecasting system.

In some implementations, the forecast optimizers 330 and/or the forecast process module 320 may also utilize one or more seasonality modules 350. The seasonality modules 350 may be configured to adjust and/or modify generated time series forecast data values to account for changes in seasonality. That is, the seasonality modules 350 may implement one or more additional predictive algorithms to modify the generated time series forecast data based on seasonality changes that may be omitted or ignored by the forecast model 340 being utilized by the forecast optimizer 330.

FIG. 4 depicts a flow diagram of an implementation of a process 400 for generating a time series forecast. The process 400 includes receiving historical time series data (block 410). The received historical time series data may be received as part of a query view through a generic time series forecasting user interface, such as the generic time series forecasting user interface 222 of FIG. 2. The received historical time series data may include sets of value pairs. In some implementations, the historical time series data may be in a data table containing the set of value pairs. Each value pair may include a timestamp and a value. The timestamp may be a specific time, e.g., 12:34.56 PM, and/or date combination. In other implementations, the timestamp may be a discretized or bucketized value, such as values indicative of a month (e.g., 1=January, 2=February, etc.), a quarter, a year, a day, etc. The values are the historic time series data to be used to generate the time series forecast using one or more predictive models.

The process 400 further includes receiving one or more initial parameter values for an exponential smoothing algorithm (block 420). The one or more initial parameter values may be predetermined initial values, such as predetermined initial values for one or more parameters for a predictive algorithm stored as part of an ahead library, such as ahead library 300 of FIG. 3. In other implementations, the one or more initial parameter values may be received with the historical time series data. For instance, the one or more initial parameter values may be received as part of the query view through the generic time series forecasting user interface, such as the generic time series forecasting user interface 222 of FIG. 2. In other implementations, the one or more initial parameter values may be retrieve from a data store or database of a backend system.

The process 400 includes iteratively determining an optimized value for each parameter of the exponential smoothing algorithm (block 430). Iteratively determining an optimized value for each parameter of the exponential smoothing algorithm may be implemented via one or more forecast optimizers utilizing one or more forecast models, such as forecast optimizers 330 and forecast models 340 of FIG. 3. The forecast optimizers may generate a set of forecasted values using a forecast model, such as a triple exponential smoothing algorithm, and one or more received initial parameter values. The forecast optimizer may then determine a fit of one or more of the set of forecasted values to one or more values of the historical and/or current time series data. The forecast optimizer may then modify a value of the one or more parameters based on the determined fit and generate a second set of forecasted values using the forecast model and the modified value of the one or more parameters. In some implementations, the forecast optimizer may be a global or local optimizer. For instance, a forecast optimizer may be a global optimizer, such as an optimizer implementing a simulated annealing process. In other implementations, the forecast optimizer may be a local optimizer, such as an optimizer implementing a Nelder Mead method. In still further implementations, both a global and a local optimizer may be utilized, such as both an optimizer implementing a simulated annealing process and an optimizer implementing a Nelder Mead method.

Iteratively determining the optimized value for each parameter for the exponential smoothing algorithm may be limited by a predetermined period of time, a predetermined number of iterations, a predetermined error value, etc. For instance, the predetermined period of time may be five seconds, ten seconds, thirty seconds, one minute, five minutes, ten minutes, etc. The forecast optimizer 330 may iteratively determine and optimize the values for the one or more parameters until the elapsed time (such as that determined using a timer) meets or exceeds the predetermined period of time. In other implementations, the predetermined number of iterations may be 10 iterations, 100 iterations, 1,000 iterations, 10,000 iterations, 100,000 iterations, 1,000,000 iterations, 10,000,000 iterations, etc. The forecast optimizer 330 may iteratively determine and optimize the values for the one or more parameters until the number of iterations meets or exceeds the predetermined number of iterations. In still further implementations, the predetermined error value may be 10%, 5%, 1%, 0.5%, 0.1%, 0.05%, 0.01%, etc. The forecast optimizer may iteratively determine and optimize the values for the one or more parameters until the error meets or is below the predetermined error value.

The process 400 may further include generating data for a forecasted time series based on the optimized values, the historical time series data, and exponential smoothing algorithm (block 440). In some implementations, generating data for the forecasted time series may simply include retrieving the last generated time series forecast data utilized by a forecast optimizer.

The process 400 further includes outputting the generated data for the forecasted time series (block 450). The generated data for the forecasted time series may output as a data file, such as a data table file, to a client device or other device. In some implementations, the generated data for the forecasted time series may also include runtime statistics, such as the number of iterations used for the overall fitting, the elapsed time, the determined error, a determined tolerance, etc. In some implementations, the values for the optimized parameters may also be included with the generated data for the forecasted time series. In still further implementations, the historical time series data may be included with the generated data for the forecasted time series. For instance, the historical time series data may be prepended, appended, or interspersed with the data for the forecasted time series. In still further implementations, the generated data for the forecasted time series may include visualization data for displaying the forecasted time series. For example, a backend system may generate a graphical display, such as a bar graph, line graph, etc. and/or combinations thereof, and may output visualization data for displaying the generated graphical on a display of a client device or other device. In some implementations, the visualization data may include the historical time series data and/or tolerance boundaries. The tolerance boundaries may be based on a determined error range for a generated time series forecast value. The tolerance boundaries may be utilized to visually show the potential range that the time series forecasted value may be other than the generated value.

In some implementations, the outputted generated data for the forecasted time series may be output to a user interface, such as the generic time series forecasting user interface 222 of FIG. 2. An underlying scripted calculation view implements by the predictive logic, such as predictive logic 234, and the outputted generated data may be transmitted to the generic time series forecasting user interface using a user interface control. The user interface control may be configured to generate the visualization data based on the generated data for the forecasted time series and the scripted calculation view may be configured to generate the actual and forecasted values.

FIG. 5 depicts an overview of an implementation of a visualization 510 and interface 500 that may be generated based on a generated time series forecast. The interface 500 may be configured using a user interface control. In some implementations, the user interface control for the interface 500 may be configured to select of a relevant scripted calculation view containing the predictive logic, such as predictive logic 234 of FIG. 2, select the view's column which shall represent a time axis (x axis) for the visualization 510, select the view's column which shall represent the value axis (y axis) for the visualization 510, display actual historical time series data differently than the forecasted time series data (such as displaying the actual historical time series data as bar graph data 520 and the forecasted time series data as line graph data 530), and/or specify the number of forecasted values in terms of how many future values shall be predicted. In some implementations, the user interface control and/or configuration data may be stored in a data table and/or handled by OData annotations.

In some implementations, the historical time series data and the forecasted time series data is included in a single data file, such as a data table, having sets of timestamps and values. The data file may sorted by timestamp such that the differentiation of the historical time series data from the forecasted time series data may be determined based on a target date (e.g. all records newer than today are forecasted values). In other implementations, the view could provide a new column (e.g. isForecasted) that would indicate which records represent actual historical time series data from forecasted time series data. The user interface control may be further configured to determine the historical time series data and the forecasted time series data based on one or more indicators of the additional column.

The interface 500 includes a legend 540 that may be displayed with or as part of the visualization 510 providing indicators (e.g., different colors, shading, etc.) for differentiating the historical time series data from the generated forecasted time series data. The user interface control for the interface 500 may also be configured to display additional information responsive to an interaction of a user with the visualization 510. For instance, the user interface control may be further configured to permit a user to interact with the underlying data, such as hovering or mousing over a portion of the visualization 510 to display information about the underlying inputted data and/or generated time series forecast data, such as a pop-up tool tip displaying the generated time series forecast data and/or the inputted data for a time value corresponding to where the mouse is positioned over the visualization 510.

FIG. 6 is a block diagram of a computer system 600 that can be used to implement the backend system 110, the client device 210, the backend system 230, and/or any other computing device described herein. The computing system 600 includes a bus 605 or other communication component for communicating information and a processor 610 or processing module coupled to the bus 605 for processing information. The computing system 600 also includes main memory 615, such as a RAM or other dynamic storage device, coupled to the bus 605 for storing information, and instructions to be executed by the processor 610. Main memory 615 can also be used for storing position information, temporary variables, or other intermediate information during execution of instructions by the processor 610. The computing system 600 may further include a ROM 620 or other static storage device coupled to the bus 605 for storing static information and instructions for the processor 610. A storage device 625, such as a solid state device, magnetic disk or optical disk, is coupled to the bus 605 for persistently storing information and instructions. Computing device 600 may include, but is not limited to, digital computers, such as laptops, desktops, workstations, personal digital assistants, servers, blade servers, mainframes, cellular telephones, smart phones, mobile computing devices (e.g., a notepad, e-reader, etc.) etc.

The computing system 600 may be coupled via the bus 605 to a display 635, such as a Liquid Crystal Display (LCD), Thin-Film-Transistor LCD (TFT), an Organic Light Emitting Diode (OLED) display, LED display, Electronic Paper display, Plasma Display Panel (PDP), and/or other display, etc., for displaying information to a user. An input device 630, such as a keyboard including alphanumeric and other keys, may be coupled to the bus 605 for communicating information and command selections to the processor 610. In another implementation, the input device 630 may be integrated with the display 635, such as in a touch screen display. The input device 630 can include a cursor control, such as a mouse, a trackball, or cursor direction keys, for communicating direction information and command selections to the processor 610 and for controlling cursor movement on the display 635.

According to various implementations, the processes and/or methods described herein can be implemented by the computing system 600 in response to the processor 610 executing an arrangement of instructions contained in main memory 615. Such instructions can be read into main memory 615 from another computer-readable medium, such as the storage device 625. Execution of the arrangement of instructions contained in main memory 615 causes the computing system 600 to perform the illustrative processes and/or method steps described herein. One or more processors in a multi-processing arrangement may also be employed to execute the instructions contained in main memory 615. In alternative implementations, hard-wired circuitry may be used in place of or in combination with software instructions to effect illustrative implementations. Thus, implementations are not limited to any specific combination of hardware circuitry and software.

The computing system 600 also includes a communications module 640 that may be coupled to the bus 605 for providing a communication link between the system 600 and a network 645. As such, the communications module 640 enables the processor 610 to communicate, wired or wirelessly, with other electronic systems coupled to the network 645. For instance, the communications module 640 may be coupled to an Ethernet line that connects the system 600 to the Internet or another network 645. In other implementations, the communications module 640 may be coupled to an antenna (not shown) and provides functionality to transmit and receive information over a wireless communication interface with the network 645.

In various implementations, the communications module 640 may include one or more transceivers configured to perform data communications in accordance with one or more communications protocols such as, but not limited to, WLAN protocols (e.g., IEEE 802.11 a/b/g/n/ac/ad, IEEE 802.16, IEEE 802.20, etc.), PAN protocols, Low-Rate Wireless PAN protocols (e.g., ZigBee, IEEE 802.15.4-2003), Infrared protocols, Bluetooth protocols, EMI protocols including passive or active RFID protocols, and/or the like.

The communications module 640 may include one or more transceivers configured to communicate using different types of protocols, communication ranges, operating power requirements, RF sub-bands, information types (e.g., voice or data), use scenarios, applications, and/or the like. In various implementations, the communications module 640 may comprise one or more transceivers configured to support communication with local devices using any number or combination of communication standards.

In various implementations, the communications module 640 can also exchange voice and data signals with devices using any number or combination of communication standards (e.g., GSM, CDMA, TDNM, WCDMA, OFDM, GPRS, EV-DO, WiFi, WiMAX, S02.xx, UWB, LTE, satellite, etc). The techniques described herein can be used for various wireless communication networks 150 such as Code Division Multiple Access (CDMA) networks, Time Division Multiple Access (TDMA) networks, Frequency Division Multiple Access (FDMA) networks, Orthogonal FDMA (OFDMA) networks, Single-Carrier FDMA (SC-FDMA) networks, etc. A CDMA network can implement a radio technology such as Universal Terrestrial Radio Access (UTRA), cdma2000, etc. UTRA includes Wideband-CDMA (W-CDMA) and Low Chip Rate (LCR). CDMA2000 covers IS-2000, IS-95, and IS-856 standards. A TDMA network can implement a radio technology such as Global System for Mobile Communications (GSM). An OFDMA network can implement a radio technology such as Evolved UTRA (E-UTRA), IEEE 802.11, IEEE 802.16, IEEE 802.20, Flash-OFDM, etc. UTRA, E-UTRA, and GSM are part of Universal Mobile Telecommunication System (UMTS). Long Term Evolution (LTE) is an upcoming release of UMTS that uses E-UTRA. UTRA, E-UTRA, GSM, UMTS, and LTE are described in documents from an organization named “3rd Generation Partnership Project” (3GPP). CDMA2000 is described in documents from an organization named “3rd Generation Partnership Project 2” (3GPP2).

Although an example computing system 600 has been described in FIG. 6, implementations of the subject matter and the functional operations described in this specification can be implemented in other types of digital electronic circuitry, or in computer software, firmware, or hardware, including the structures disclosed in this specification and their structural equivalents, or in combinations of one or more of them.

Implementations of the subject matter and the operations described in this specification can be implemented in digital electronic circuitry, or in computer software embodied on a non-transitory tangible medium, firmware, or hardware, including the structures disclosed in this specification and their structural equivalents, or in combinations of one or more of them. The subject matter described in this specification can be implemented as one or more computer programs, i.e., one or more modules of computer program instructions, encoded on one or more computer storage media for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate components or media (e.g., multiple CDs, disks, or other storage devices). Accordingly, the computer storage medium is both tangible and non-transitory.

The operations described in this specification can be performed by a data processing apparatus on data stored on one or more computer-readable storage devices or received from other sources.

The terms “data processing apparatus,” “computing device,” “data processor,” or “processing circuit” encompasses all kinds of apparatus, devices, and machines for processing data, including by way of example a programmable processor, a computer, a system on a chip, or multiple ones, a portion of a programmed processor, or combinations of the foregoing. The apparatus can include special purpose logic circuitry, e.g., an FPGA or an ASIC. The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a standalone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing actions in accordance with instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive), to name just a few. Devices suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

While this specification contains many specific implementation details, these should not be construed as limitations on the scope of what may be claimed, but rather as descriptions of features specific to particular embodiments. Certain features described in this specification in the context of separate embodiments can also be implemented in combination in a single implementation. Conversely, various features described in the context of a single implementation can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated in a single software product or packaged into multiple software products embodied on tangible media.

References to “or” may be construed as inclusive so that any terms described using “or” may indicate any of a single, more than one, and all of the described terms.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain embodiments, multitasking and parallel processing may be advantageous.

The claims should not be read as limited to the described order or elements unless stated to that effect. It should be understood that various changes in form and detail may be made by one of ordinary skill in the art without departing from the spirit and scope of the appended claims. All embodiments that come within the spirit and scope of the following claims and equivalents thereto are claimed.

What is claimed is:

1. A method for generating a time series forecast comprising:
receiving historical time series data from a client device;
receiving one or more initial parameter values for an exponential smoothing algorithm;
iteratively determining, using one or more processors, an optimized value for each of one or more parameters for the exponential smoothing algorithm based on the received historical time series data and the received one or more initial parameter values;
generating, using one or more processors, data for a forecasted time series based on the iteratively optimized value for each of the one or more parameters, the received historical time series data, and the exponential smoothing algorithm; and
outputting the generated data for the forecasted time series to the client device.

2. The method of claim 1, wherein the historical time series data comprises a plurality of value pairs of a timestamp and a value.

3. The method of claim 1, wherein the outputting the generated data for the forecasted time series comprises visualization data for displaying the forecasted time series.

4. The method of claim 3, wherein the visualization data further comprises the historical time series data.

5. The method of claim 4, wherein the visualization data further comprises data for tolerance boundaries.

6. The method of claim 1, wherein the exponential smoothing algorithm is a triple exponential smoothing algorithm.

7. The method of claim 1, wherein iteratively determining the optimized value for each of the one or more parameters for the exponential smoothing algorithm is limited by a predetermined period of time.

8. The method of claim 1, wherein iteratively determining the optimized value for each of the one or more parameters for the exponential smoothing algorithm comprises:
generating a set of forecasted values using the exponential smoothing algorithm and the one or more initial parameter values; and
determining a fit of one or more of the set of forecasted values to one or more values of the historical time series data using an optimizer.

9. The method of claim 8, wherein the optimizer is one of a global optimizer or a local optimizer.

10. The method of claim 8, wherein the optimizer is a simulated annealing optimizer.

11. The method of claim 8, wherein the optimizer is a Nelder-Mead optimizer.

12. A system comprising:
one or more processors; and a non-transitory computer-readable storage device storing instructions that, when executed by the one or more processors, cause the one or more processors to perform operations comprising:
receiving historical time series data;
receiving one or more initial parameter values for a triple exponential smoothing algorithm;
iteratively determining an optimized value for each of the one or more parameters for the triple exponential smoothing algorithm based on the received historical time series data and the received one or more initial parameter values;
generating data for a forecasted time series based on the iteratively optimized value for each of the one or more parameters, the received historical time series data, and the triple exponential smoothing algorithm; and
outputting the generated data for the forecasted time series.

13. The system of claim 12, wherein iteratively determining the optimized value for each of the one or more parameters for the triple exponential smoothing algorithm is limited by a predetermined period of time.

14. The system of claim 12, wherein iteratively determining the optimized value for each of the one or more parameters for the triple exponential smoothing algorithm comprises:
generating a set of forecasted values using the triple exponential smoothing algorithm and the one or more initial parameter values;
determining a fit of one or more of the set of forecasted values to one or more values of the historical time series data using an optimizer;
modifying a value of the one or more parameters based on the determined fit; and
generating a second set of forecasted values using the triple exponential smoothing algorithm and the modified value of the one or more parameters.

15. The system of claim 14, wherein the optimizer is one of a global optimizer or a local optimizer.

16. The system of claim 12, wherein the outputting the generated data for the forecasted time series comprises visualization data for displaying the forecasted time series.

17. The system of claim 16, wherein the visualization data further comprises the historical time series data.

18. A non-transitory computer-readable storage device storing instructions that, when executed by one or more processors, cause the one or more processors to perform operations comprising:
receiving historical time series data;
receiving a plurality of initial parameter values for a triple exponential smoothing algorithm;
iteratively determining an optimized value for each of a plurality of parameters for the triple exponential smoothing algorithm based on the received historical time series data and the received plurality of initial parameter values, the iterative determination of the optimized values for each of the plurality of parameters for the triple exponential smoothing algorithm comprising:
generating a set of forecasted values using the triple exponential smoothing algorithm and the plurality of initial parameter values; and
determining a fit of one or more of the set of forecasted values to one or more values of the historical time series data using an optimizer;
generating data for a forecasted time series based on the iteratively optimized value for each of the plurality of parameters, the received historical time series data, and the exponential smoothing algorithm; and
outputting the generated data for the forecasted time series in a view.

19. The non-transitory computer-readable storage device of claim 18, wherein iteratively determining the optimized value for each of the plurality of parameters for the triple exponential smoothing algorithm is limited by a predetermined period of time.

20. The non-transitory computer-readable storage device of claim 18, wherein the optimizer is one of a global optimizer or a local optimizer.
